(19) United States
(12) Patent Application Publication
(10) Pub. No.: US 2011/0293965 A1
(43) Pub. Date: Dec. 1, 2011

(54) LUBRICANT AND MAGNETIC DISK DEVICE USING SAME

(76) Inventors: Yoko Saito, Ishioka (JP); Tomio Iwasaki, Tsukuba (JP); Naoya Sasaki, Kasama (JP); Mina Amo, Hitachi (JP)

(21) Appl. No.: 13/146,078

(22) PCT Filed: Dec. 11, 2009
(86) PCT No.: PCT/JP2009/006802

§ 371 Date: Aug. 17, 2011

(30) Foreign Application Priority Data
Jan. 26, 2009 (JP) 2009-014275

(51) Int. Cl. C08G 65/22; G11B 5/725

(52) U.S. Cl. 428/800; 528/402

(57) ABSTRACT

In a lubricant including a structure of a polymer compound, the structure includes polar groups or side chains having polarity at terminal ends and in at least one intermediate portion of a main chain, and also includes non-polar side chains at the terminal ends or in the intermediate portions of the main chain. For example, any of —OH, —CH₂OH, —COOH, —NH₂, and —CH₂OCH₂CH(OH)CH₂OH groups is used for the polar group or the side chain having polarity, and a side chain including the structure of the formula (5) or (6) is used for the non-polar side chain.

Then, in the lubricant used for a magnetic disk device, the surface energy is suppressed to a low level while a thin film thickness is being kept small for one molecule, thereby realizing stabilization of head-disk interface in the magnetic disk device for a long time.

—(CF₂O)_{P}—CF₃ (5)

—(CF₂)_{P}—CF₃ (6)

(where P represents an integer of 0 or greater in the formulas (5) and (6)).

### TECHNICAL FIELD

The present invention relates to a lubricant and a magnetic disk device using the same. The invention relates to a lubricant suitable to stabilization of an interface between a magnetic head and a magnetic disk while keeping the flying height of the head low, as well as a magnetic disk device using the same.

### BACKGROUND ART

In recent years, the flying height of magnetic heads has been decreased to about 10 nm along with increase in the recording density in magnetic disk devices. If a magnetic head is in contact with and sliding movement with a magnetic recording medium frequently, then the magnetic recording medium will suffer from damage due to abrasion. To suppress such damage, the medium is formed with an overcoat and a lubrication layer on the surface thereof. The flying height will tend to be decreased year by year in the feature and it is anticipated that a probability that the magnetic head is in direct contact with the disk increases rapidly. Further, along with increase in the speed of the rotation and the reduction in the film thickness of the lubrication layer, it has become difficult to keep the lubricant uniformly on the disk surface, and control of the lubrication layer has become an important subject.

A diamond-like carbon (DLC: Diamond-Like Carbon) film with high hardness has been used frequently as a surface overcoat to prevent friction and wear due to sliding movement between the head and the disk. When the DLC film is used as an overcoat, the surface thereof is covered with a thin oxide film having functional groups such as reactive carbonyl groups, carboxyl groups, and hydroxyl groups, and contaminants are tend to be adsorbed thereon. Then, in the conventional magnetic disk devices, the surface of the overcoat is thoroughly covered with a lubricant to prevent adsorption of contaminants such as toxic gasses or organic materials, on the surface and, further, improve the lubrication property, thereby achieving a stable magnetic disk device having satisfactory durability.

It is necessary that the lubricant used for improving the lubrication property at the surface of the magnetic disk be stably formed at a uniform film thickness on the surface of the overcoat. Also, it is important that the adhesion and bonding property of the lubricant to the overcoat is high. To enhance the adhesion property, perfluoropolyether type lubricants having terminal polar groups such as hydroxyl groups or piperonyl groups have been used generally.

When the molecular weight of the lubricant is small, the film thickness is remarkably reduced due to scattering of the lubricant by the rotation of a disk and this brings about head crush in the worst case. In contrast, when the molecular weight is increased, the radius of gyration of one molecule increases, so that this results in a problem in that decrease in the flying height is hindered.

Patent Document 1 discloses a lubricant using a fluoro-containing polymer produced by causing a compound having a specific structure to react with 1,3-butadiene epoxide. It is described that using this lubricant can decrease the film thickness for one molecule and improve the reliability in wide temperature circumstances without impairing the flying stability. Such a surface form of molecule has been studied in details also by simulation analysis by computers (for example, refer to non-patent document 1).

### PRIOR ART REFERENCES

### Patent Document

Patent Document 1: JP-A-2007-284659

### Non-Patent Document

Non-Patent Document 1: Haigang Chen et al., “Effects of Molecular Structure on the Conformation and Dynamics of Perfluoropolyether Nanofilms”, IEEE TRANSACTIONS ON MAGNETICS, JUNE 2007, VOL. 43, NO. 6, p. 2247-2249

### SUMMARY OF THE INVENTION

### Problem to be Solved by the Invention

However, as described in the Patent Document 1, when a plurality of polar groups are disposed in intermediate portions of a polymer, the film thickness for one molecule is decreased, but the surface energy of the lubrication film may also possibly increase due to increase of the polar groups. When the surface energy increases, contaminant materials tend to adhere to the surface and, in addition, the lubricant also tends to adhere to the head.

The present invention has been made for solving the problems described above and the object thereof is to provide a lubricant used for a magnetic disk device, the lubricant being capable of suppressing the surface energy to a low level while keeping the film thickness for one molecule small, thereby realizing stabilization of a head-disk interface in the magnetic disk device for a long time.

### Means for Solving the Problem

The lubricant of the present invention has a structure of a polymer compound, the structure including polar groups or side chains having polarity at terminal ends and in at least one intermediate portion of a main chain, and including non-polar side chains at the terminal ends or in the intermediate portions of the main chain.

More specifically, the main chain of the polymer compound comprises a combination of structural units of any of formulas (1), (2), (3), and (4).

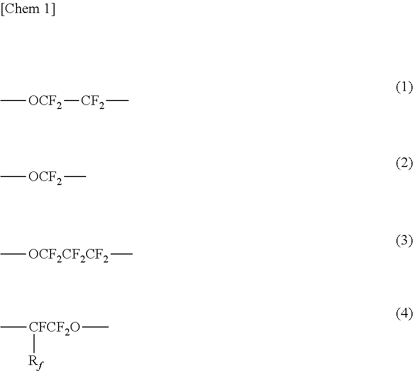

(where R_{f} represents a non-polar side chain in the formula (4)).

Further, the polar group or the side chain having polarity includes, specifically, any of —OH, —CH₂OH, —COOH, —NH₂, —CH₂OCH₂CH (OH) CH₂OH groups.

The non-polar side chain comprises, specifically, a structure of the formula (5) or (6).

### [Chem 2]

—(CF₂O)_{P}—CF₃ (5)

—(CF₂)_{P}—CF₃ (6)

(where P represents an integer of 0 or greater in the formulas (5) and (6))

With this constitution of the lubricant, a lubricant having a thin film thickness for one molecule is formed and the surface energy of a lubrication film is also kept low at the same time. Further, when such a lubricant is used for a magnetic disk device, it is possible to form a lubrication film satisfactory for preventing adhesion of contaminants and preventing the lubricant from adhering to the head while contributing to decreasing of the flying height of the head.

### Effect of the Invention

The present invention can provide a lubricant used for a magnetic disk device, the lubricant being capable of suppressing the surface energy to a low level while keeping the film thickness for one molecule small, thereby realizing stabilization of a head-disk interface in the magnetic disk device for a long time.

### BRIEF DESCRIPTION OF THE DRAWINGS

FIG. 1 is a view showing a state when a lubricant according to an embodiment of the invention is coated on a substrate.

FIG. 2 is across sectional view of a magnetic disk medium.

FIG. 3 is a top view of a magnetic disk device.

FIG. 4 is a view schematically showing the analysis result of a lubricant according to the embodiment of the present invention by molecular dynamics simulation.

FIG. 5 is a view schematically showing the analysis result of a lubricant according to the conventional technique by molecular dynamics simulation.

### MODE FOR CARRYING OUT THE INVENTION

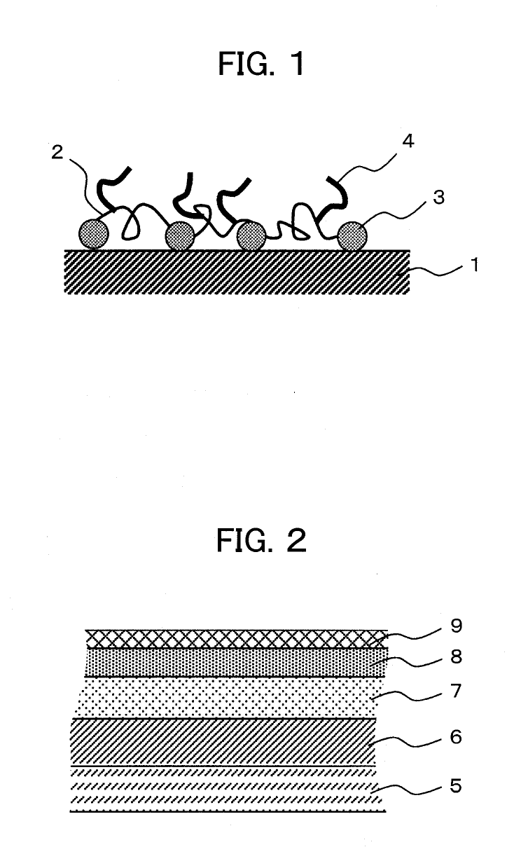

An embodiment according to the present invention is to be described below with reference to FIGS. 1 to 5 and chemical formulas.

First, a method of producing a lubricant according to this embodiment is to be described by way of chemical formulas.

The main chain structure of the lubricant polymer in this embodiment is prepared, for example, by dissolving a polymer represented by the following general formulas (7) and (8) in a fluoro solvent and subjecting the same to polymerizing reaction.

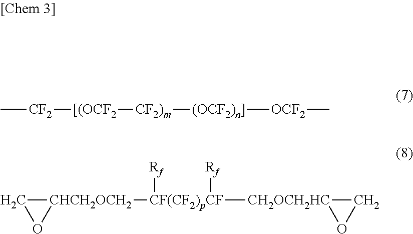

m and n in the formula (7) each represent an integer of 0 or greater. Further, both terminal ends have polar functional groups such as —CH₂OH, —COOH, —NH₂, or —CH₂OCH₂CH(OH)CH₂OH group. The functional group may be present only on one side of the terminal ends. The chemical formula (8) represents a molecule having epoxy groups on both terminal ends in which p represents an integer of 1 or greater.

OCF₂CF₂ and OCF₂ in the formula (7) may also be substituted with the formula (9) or (10).

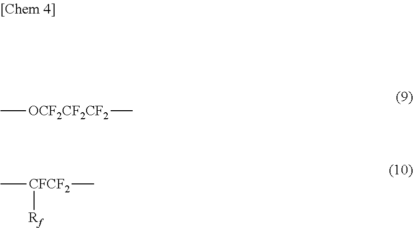

R_{f} in the formula (8) and (10) represents a non-polar side chain and when a fluorine-type side chain shown, for example, in the formula (11) or the formula (12) is used, the surface energy is suppressed to a low level.

### [Chem 5]

—(CF₂O)_{P}—CF₃ (11)

(CF₂)_{P}—CF₃ (12)

p represents an integer of 0 or greater. For suppressing the increase in the film thickness, p is desirably restricted to 7 or less. The polymer of the formula (7) or (8) obtained by the synthesis reactions has a structure that includes polar groups at both terminal ends and in the intermediate portion and, at the same time, that includes non-polar side chain in the intermediate portion. The position for the polar group and the position for the non-polar side chain may be displaced.

Then, description is to be given of a state in which the lubricant according to the embodiment of the present invention is coated on a substrate with reference to FIG. 1.

FIG. 1 is a view showing a state in which the lubricant according to the embodiment of the present invention is coated on the substrate.

FIG. 1 shows a stable state of one molecule of a lubricant polymer according to the embodiment when it is coated on the surface of a substrate having polar groups. A lubricant polymer having a main chain 2 is adsorbed on a substrate 1. Polar groups 3 are bonded to polar groups on the substrate by means of hydrogen bond. Non-polar side chains 4 are directed towards a space. The polar groups of the lubricant are directed towards the substrate, adsorption force to the substrate can therefor be improved. By the direction of the non-polar side chains toward the space, the surface energy of the lubrication film can be reduced. Thus, the effect of decreasing the adhesion of contaminant materials and reducing the frictional force can be expected and the lubrication property can be improved.

The polar group 3 may be a side chain having a polarity. It may suffice that the polar groups 3 or the side chains having polarity are present at the terminal end and in at least one intermediate portion of the main chain. Further, it may suffice that at least one non-polar side chain is present at the terminal end or in the intermediate portion of the main chain.

When the number of polar groups in one molecule is excessively large, the cohesive force between the polymers is larger than the adsorption force to the substrate. As a result, coverage of the lubrication film may possibly be decreased. Therefore, it is considered that the number of intermediate polar groups is appropriately about 1 to 8 in the case of polymer having an average molecular weight, for example, of 3,000 g/mol. The number may be increased as the molecular weight increases.

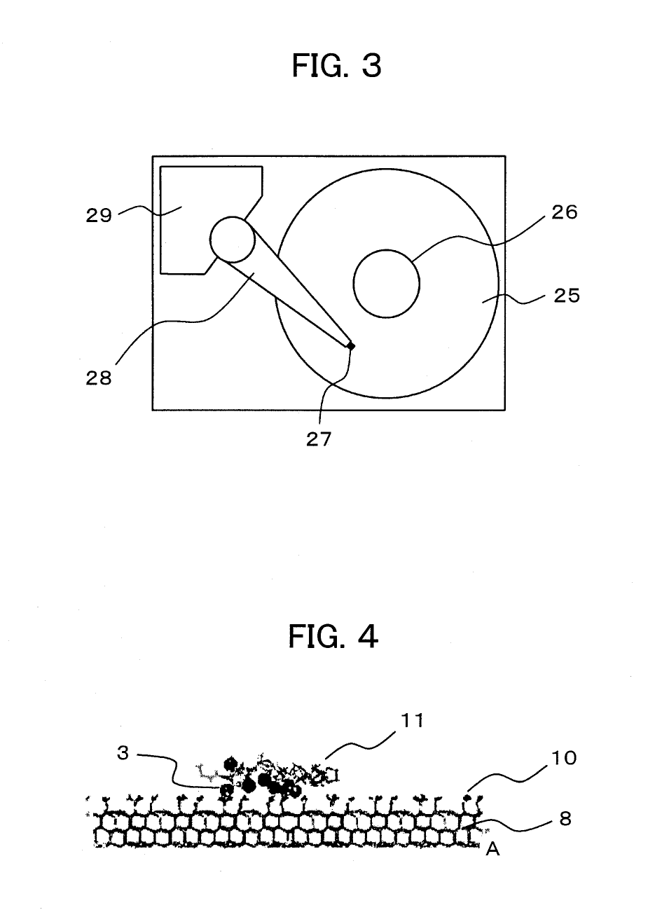

Then, a magnetic disk medium and a magnetic disk device using a lubricant according to an embodiment of the present invention are to be briefly described with reference to FIGS. 2 and 3.

FIG. 2 is a cross sectional view of the magnetic disk medium.

FIG. 3 is a top view of the magnetic disk device.

The structure of the magnetic disk medium comprises, as shown in FIG. 2, a substrate 5 (non-magnetic support), an underlayer film 6, a magnetic film 7, an overcoat 8, a lubrication film 9, etc. The underlayer film 6 may be omitted. The lubrication film 9 is coated on the overcoat 8. The lubricant has a structure as shown in FIG. 1 that includes polar groups at both terminal ends (or one terminal end) and in intermediate portions, and that also includes non-polar side chains in the intermediate portions at the same time. When the molecular weight is too small, it may possibly result in deterioration of the lubrication property and reduction in the film thickness due to evaporation of the lubricant and scattering of the lubricant by the rotation of the disc. In contrast, when the molecular weight is excessively large, the film thickness increases. Therefore, the average molecular weight is desirably between 500 to 6000 g/mol.

The structure of the magnetic disk device usually includes, as shown in FIG. 3, a magnetic disk 25 for recording and storing data, a motor 26 for rotating the magnetic disk, a magnetic head 27 for reading and writing magnetic data from and to a magnetic recording layer on the surface of the magnetic disk medium, an arm 28 for supporting the magnetic head 27, and a positioning device 29 for controlling the position of the magnetic head 27.

The surface of a carbon overcoat forming the overcoat 8 is modified with polar groups such as reactive carbonyl groups, carboxyl groups, or hydroxyl groups, etc. A strong bonding force is generated at the interface between the overcoat and the lubrication film by the bonding of these polar groups to the polar groups of the lubricant.

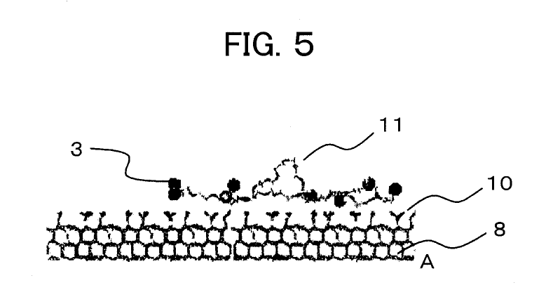

The effect of the present invention is to be described below with reference to FIGS. 4 and 5.

FIG. 4 is a view schematically showing the analysis result of the lubricant according to the embodiment of the present invention by molecular dynamics simulation.

FIG. 5 is a view schematically showing the analysis result of the lubricant according to the conventional technique by molecular dynamics simulation.

FIG. 4 shows the analysis result of investigating the lubricant according to the embodiment of the present invention by molecular dynamics simulation. In the analysis model, a substrate in which polar groups (—OH group) 10 are evenly disposed on the surface of the overcoat 8 (diamond-like carbon film) is assumed and a model in which a lubricant polymer 11 with a molecular weight of about 2500 g/mol is adhered to the substrate was used. The lubricant molecule comprises a structure in which eight polar groups (—OH group) in total are attached at the terminal ends and in the intermediate portions of the polymer, and four non-polar side chains (p=2 in the formula (12)) are attached in the intermediate portions of the polymer. In the analysis of the adhesion form, a prepared polymer was disposed on the substrate and molecular dynamics calculation was performed till the energy of the entire system was stabilized at a room temperature. The polar groups 3 of the polymer (large circles in FIG. 4) tend to direct towards the substrate. In contrast, since fluorine-type main chains and side chains direct upward to take a form of concealing the polar groups of the lubricant polymer, reduction in the surface energy can be expected.

On the contrary, FIG. 5 shows a stable state in which only the polar groups are present at the terminal ends and in the intermediate portions of the polymer without non-polar side chains. While the film thickness of the lubricant molecule is reduced, portions where the polar groups are exposed to the surface of the lubrication film are formed and the surface energy tends to increase more than that in the form shown in FIG. 4.

As has been described above, according to the lubricant of this embodiment, the thickness of the lubrication film can be kept small and, at the same time, the surface energy of the lubrication film can be decreased to thereby form a satisfactory lubrication film which is effective also for lowering the flying height of the head, preventing adhesion of the contaminant materials, and preventing adhesion of the lubricant to the head. Further, by the use of the lubricant of this embodiment, a magnetic disk device that is capable of realizing high reliability in the head-disk interface for a long time can be manufactured.

### DESCRIPTION OF THE REFERENCE NUMERALS

1 . . . Substrate
2 . . . Main chain of lubricant polymer
3 . . . Polar group or side chain having polarity of lubricant polymer
4 . . . Non-polar side chain
5 . . . Substrate (non-magnetic support)
6 . . . Underlayer
7 . . . Magnetic film
8 . . . Overcoat
9 . . . Lubrication film
10 . . . Polar group (—OH group) on carbon overcoat
11 . . . Lubricant polymer
25 . . . Magnetic disk
26 . . . Motor
27 . . . Magnetic head
28 . . . Arm
29 . . . Positioning device

1. A lubricant comprising a structure of a polymer compound, the structure including polar groups or side chains having polarity at terminal ends and in at least one intermediate portion of a main chain, and including at least one non-polar side chain at the terminal ends or in the intermediate portions of the main chain.

2. The lubricant according to claim 1, wherein the main chain of the polymer compound comprises a combination of structural units of any of the formulas (1), (2), (3), and (4): 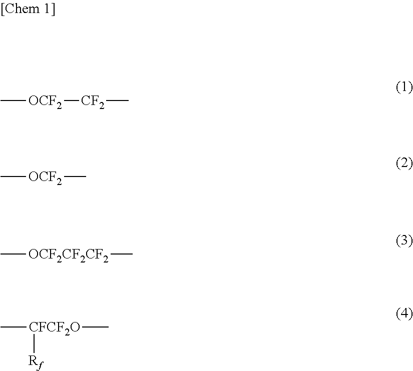
(where R_{f} represents a non-polar side chain in the formula (4)).

3. The lubricant according to claim 1, wherein the polar group or the side chain having polarity contains any of —OH, —CH₂OH, —COOH, —NH₂, and —CH₂OCH₂CH(OH)CH₂OH groups.

4. The lubricant according to claim 1, wherein the non-polar side chain comprises the structure of the formula (5) or the formula (6).
[Chem 2]
—(CF₂O)_{P}—CF₃ (5)
—(CF₂)_{P}—CF₃ (6)
(where P represents an integer of 0 or greater in the formulas (5) and (6)).

5. The lubricant according to claim 1, wherein the polymer compound is obtained by synthesis reaction of a fluorine-type polymer having polarity at both or either one of terminal ends, and a polymer having epoxy groups on both terminal ends.

6. The lubricant according to claim 1, wherein the average molecular weight of the polymer compound is 500 or more and 6000 or less, and the number of polar group or the side chain having polarity in one molecule is in a range of 1 to 20 and the number of non-polar side chains in one molecule is in a range of 1 to 20.

7. A magnetic disk device in which a lubrication layer is formed on a disk surface, wherein a lubricant used for the lubrication layer is the lubricant described according to any one of claims 1 to 6.
